(19) United States
(12) Patent Application Publication
(10) Pub. No.: US 2010/0071519 A1
(43) Pub. Date: Mar. 25, 2010

(54) METHOD AND DEVICE FOR DIVIDING METAL STRIP

(76) Inventors: Oliver Abel, Hilden (DE); Peter De Kock, Oberhausen (DE)

Correspondence Address: K.F. ROSS P.C., 5683 RIVERDALE AVENUE, SUITE 203 BOX 900, BRONX, NY, 10471-0900, US

(21) Appl. No.: 12/447,293

(22) PCT Filed: Oct. 18, 2007
(86) PCT No.: PCT/EP07/09008

§ 371 Date: Apr. 27, 2009

(30) Foreign Application Priority Data
Oct. 31, 2006 (DE) 10 2006 051 349.5

(51) Int. Cl. B23D 15/06; B23D 33/02

(52) U.S. Cl. 83/13; 83/382

(57) ABSTRACT

In the case of a method for dividing metal strip, by means of shears (1) for dividing up metal strips (7) transversely in relation to the strip running direction in strip plants, wherein an upper cutter carrier (4) and a lower cutter carrier (2) on one side have an upper cutter (5) and a lower cutter (3) and on the other side are mounted on a common rotational spindle (6) and the metal strip (7) is at a standstill during the cutting operation, and wherein the upper cutter is formed in a stationary manner and the lower cutter is formed in a movable manner, the lower cutter (3) performs an arcuate movement towards the stationary upper cutter (5). The invention also relates to a device for carrying out the method according to the invention.

The invention relates to a method of subdividing a metal strip in a strip mill with a shear transversely to a travel direction of the strip, upper and lower blade supports having respective upper and lower blades at one end and being supported at their other ends at a common pivot, the metal strip being stopped during the cutting process. The invention furthermore relates to an apparatus for implementing the method.

A shear of the is standard type is known from DE 103 61 844. In this known shear, the upper blade support performs a pincer-like movement, while the upper blade moves through an arc toward the lower blade.

The apparatus, also known as an IPR shear (integrated pinch roll), is used in strip mills both in the in-feed region and in the discharge region in order to cut off the leading end of the strip and/or the trailing end of the strip, or to perform a separating cut in continuously running strip mills. According to the typical cutting sequence and geometry of the shearing blades, the strip, for example, steel strip, is cut from above and below. The upper blade thus moves past the stationary lower blade.

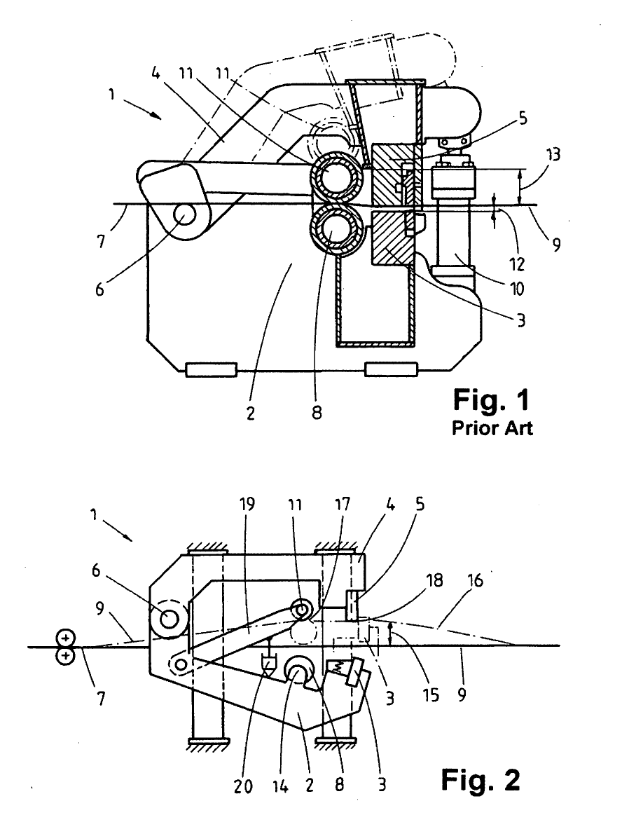

In the known configuration, the integrated pinch roller unit is attached to the fixed lower blade frame such that the travel path of the strip can be kept constant within the strip mill. In order to ensure appropriate clearance of the strip from the blades when the shear is open, the lower blade is set approximately 25 to 35 mm lower than the lower pinch roller while the upper blade is set approximately 150 to 175 mm above the strip so as to prevent the traveling strip from striking the blades while the strip mill is operating. See FIG. 1.

What is disadvantageous about this type of shear is that the cut burr is on the bottom of the metal strip or metal strips, and the conveyor rollers can be damaged by it during subsequent travel.

The basic object of the invention is thus to prevent the above-referenced disadvantages.

This object is attained according to the invention by an approach wherein in the method specified in the preamble of claim 1 the lower blade moves through an arc toward the stationary upper blade. What is achieved by cutting upwardly is that the cutting burr projects upward from the upper face of the metal strip. Since on the other hand only the bottom face is in contact with the conveyor rollers and this side does not have any cutting burr, the conveyor rollers are protected and not damaged.

Additional embodiments of the method are revealed in the relevant dependent claims.

In addition, the invention relates to an apparatus for implementing the method according to the invention.

Additional embodiments of the apparatus are given in the relevant dependent claims.

The critical advantage of the method according to the invention lies in the fact that the cut is performed from below upward and the cutting burr is projects upward from the metal strip. Due to the fact that the cutting burr is located on the upper face, the downstream rollers on which the metal strip is conveyed are protected.

In order to ensure in the method according to the invention that there is sufficiently large clearance relative to the metal strip when the installation is operating, what is proposed in a development of the invention is that the metal strip be lifted upward from the normal strip-travel path. In contrast to the prior art, the integrated lower pinch roller is not attached to the stationary blade frame and thus does not hold the strip on a fixed normal strip-travel path; instead the lower pinch roller is attached to the movable lower blade support. When the lower blade support is lifted—for example, by a hydraulic cylinder—the lower pinch roller is thus applied to the metal strip and lifts the strip from the normal strip-travel path onto a raised strip-travel raised strip position. The metal strip is thus lifted from its normal strip-travel path in the installation and moves along with the lower blade toward the cutting/subdividing operation.

An additional advantageous aspect is that the upper pinch roller is carried by a mount on which the lower blade support is supported by the above-referenced hydraulic cylinder.

An embodiment of the invention is described in detail on the basis of schematic drawings. Therein:

FIG. 1 is a side view of a known shear for subdividing a metal strip, and

FIG. 2 is a side view of a shear according to the invention.

FIG. 1 illustrates the known prior art. A shear 1 composed of a lower blade support 2 carrying a lower blade 3 on its right side, as viewed in the travel direction of the strip, and an upper blade support 4 carrying an upper blade 5 on its right side, the lower blade support 2 and the upper blade support 4 being attached on their left sides to a common pivot spindle 6, is designed such that the lower blade support 2 is stationary while the upper blade support 4 is movable. In other words, the upper blade support 4 along with the upper blade 5 is moved downward to cut the metal strip 7. A lower pinch roller 8 is attached to the lower blade support 2 at the level of the normal strip-travel path 9. The lower pinch roller 8 is fixed. The upper blade support 4 is moved toward or away from metal strip 7 by a hydraulic cylinder 10. An upper pinch roller 11 is attached to the upper blade support 4 or a separate support (not shown). In order to cut metal strip 7, the upper pinch roller 11 is moved down onto the metal strip, either along with the upper blade support 4 or separately. The lower blade 3 is set, as already mentioned above, with a vertical spacing 12 below the normal strip-travel path 9. With the shear 1 open, the upper blade 5 has a vertical clearance 13 relative to the normal strip-travel path 9.

FIG. 2 shows a shear according to the invention, where the individual components of the shear have reference numbers that are identical to the one of the prior art shown in FIG. 1.

The upper blade support 4 along with the upper blade 5 is attached by the pivot spindle 6 to the lower blade support 2 and to the lower blade 3 attached thereon. In the shear 1 according to the invention, the upper blade support 4 is stationary. To this end, the upper blade support 4 is of a suspended overhead design in a first embodiment. In a second embodiment, provision is made for the upper blade support 4 to be anchored in a stationary frame. In both embodiments, the upper blade support 4 is fixed. The movable lower blade support 2 along with the lower blade 3 is pivoted on the spindle 6 against the metal strip 7 to divide the strip. The lower pinch roller 8 is here mounted on the lower blade support 2 by means of an appropriate bearing 14. The upper blade support 5 is set at a spacing 15 above the normal strip-travel path 9. In order to cut metal strip 7, the strip is displaced by the lower pinch roller 8 from the normal strip-travel path 9 upward to a raised strip position 16. Simultaneously, the lower blade 3 is moved upward to cut the metal strip 7. Opposite lower pinch roller 8 is an upper pinch roller 11. The lower edge 17 of the upper pinch roller 11 is level with the lower edge 18 of the upper blade 5. The upper pinch roller 11 here is carried on a mount 19. The lower blade support 2 is movably coupled by a hydraulic cylinder 20 to the mount 19 in order to rotate the lower blade support 2 about the spindle 6 so as to cut the metal strip 7. The upper pinch roller 11 is positioned in a fixed manner by the mount 19.

### LIST OF REFERENCE NUMBERS

1 shear
2 lower blade support
3 lower blade
4 upper blade support
5 upper blade
6 rotational spindle
7 metal strip
8 lower pinch roll
9 normal strip-travel path
10 hydraulic cylinder
11 upper pinch roll
12 vertical clearance
13 vertical clearance
14 bearing arrangement
15 vertical clearance
16 raised strip position
17 lower edge upper pinch roll
18 lower edge upper blade
19 mount
20 hydraulic cylinder

1-8. (canceled)

9. A method of transversely subdividing metal strip advancing longitudinally along a normal strip-travel path between an upper blade and upper pinch roller and a lower blade and a lower pinch roller, the method comprising the steps of:
continuously holding the upper blade at a spacing above the normal strip-travel path;
without moving the upper blade, periodically stopping longitudinal advance of the strip and pressing the lower pinch roller upward against the strip to raise the strip to a raised position engaging the upper blade; and thereafter
without moving the upper blade, moving the lower blade upward into engagement with and then through the strip in the raised position to transversely cut the strip between the blades.

10. The method defined in claim 9 wherein the lower blade is pivoted about a transverse axis on upward movement to cut the strip.

11. The method defined in claim 9 wherein the lower pinch roller is pivoted about a transverse axis to press the strip upward.

12. The method defined in claim 11, further comprising the step of
pinching the strip between the upper and lower pinch rollers before cutting the strip transversely.

13. An apparatus for transversely subdividing metal strip advancing longitudinally along a normal strip-travel path, the apparatus comprising:
an upper blade and an upper pinch roller above the strip;
a lower blade and a lower pinch roller below the strip;
a support continuously holding the upper blade at a spacing above the normal strip-travel path; and
actuator means for, when longitudinal advance of the strip has been stopped, pressing the lower pinch roller upward against the strip to raise the strip to a raised position engaging the upper glade and thereafter moving the lower blade upward into engagement with and then through the strip to transversely cut the strip between the blades.

14. The apparatus defined in claim 13, further comprising
a transversely extending pivot carrying the lower blade and pinch roller for arcuate movement about a transverse axis.

15. The apparatus defined in claim 13, further comprising
actuator means for pulling down the upper pinch roller and pinching the strip between the upper and lower pinch rollers before engaging the lower blade through the strip.

16. The apparatus defined in claim 16 wherein the lower blade and the lower pinch roller are mounted at ends of respective pivotal support arms, the actuator means of pulling down being a hydraulic cylinder engaged between the arms.
